(19) United States
(12) Patent Application Publication
(10) Pub. No.: US 2017/0145751 A1
(43) Pub. Date: May 25, 2017

(54) DOWNHOLE TOOLS WITH LOW DILUTION ZONE BEARING CLADDING AND CLADDING PROCESSES

(71) Applicant: Halliburton Energy Services, Inc., Houston, TX (US)

(72) Inventor: Jay Stuart Bird, The Woodlands, TX (US)

(73) Assignee: Halliburton Energy Services, Inc., Houston, TX (US)

(21) Appl. No.: 15/323,874

(22) PCT Filed: Aug. 5, 2014
(86) PCT No.: PCT/US14/49790

§ 371 Date: Jan. 4, 2017

(51) Int. Cl. E21B 10/22; F16C 33/12; B22F 3/00; B22F 7/04; B22F 3/10

(52) U.S. Cl. CPC E21B 10/22; B22F 7/04; B22F 3/1017; B22F 3/003; F16C 33/125; B22F 2007/047; B22F 2005/001

(57) ABSTRACT

The present disclosure relates to downhole tools containing bearings with cladding on their surfaces. The cladding contains a low dilution zone. In specific embodiments, the downhole tools may be roller cone drill bits, also sometimes referred to as rotary cone drill bits. The present disclosure further relates to processes for applying cladding to bearings.

### TECHNICAL FIELD

The present disclosure relates to boring or penetrating the earth with a bit or bit element, such as a rolling cutter bit. It also relates to bearings for drill bits.

### BACKGROUND

Downhole tools, such as earth-boring drill bits, often contain moving parts. Friction between moving parts is often reduced by introducing at least one bearing between the parts. However, the bearings themselves can overheat due to friction and experience wear, including galling, over time. As a result, materials are often welded to surfaces of bearings to reduce friction or increase wear-resistance. Currently, such materials are typically applied to bearings using a high dilution arc welding process. Such processes produce non-homogenous materials with a large metallurgical bond area in which the material is highly diluted with iron or other metals from the underlying substrate-, which results in poor anti-galling and other wear properties as compared to what is theoretically possible for the cladding materials used.

### BRIEF DESCRIPTION OF THE DRAWINGS

A more complete understanding of the present embodiments and advantages thereof may be acquired by referring to the following description taken in conjunction with the accompanying drawings, which show particular embodiments of the current disclosure, in which like numbers refer to similar components, and in which:

FIG. 1A is schematic drawing showing an isometric view of one embodiment of a roller cone drill bit;

FIG. 2 is a cross-section of a support arm with journal or spindle and roller cone assembly from a roller cone drill bit;

FIG. 3 is a cross-section of a bearing surface of a roller spindle from a roller cone drill bit; and

FIG. 4 depicts a cladding process.

### DETAILED DESCRIPTION

The present disclosure relates to downhole tools containing bearings. The bearings have cladding with a low dilution zone. The disclosure also relates to cladding processes to produce such bearings.

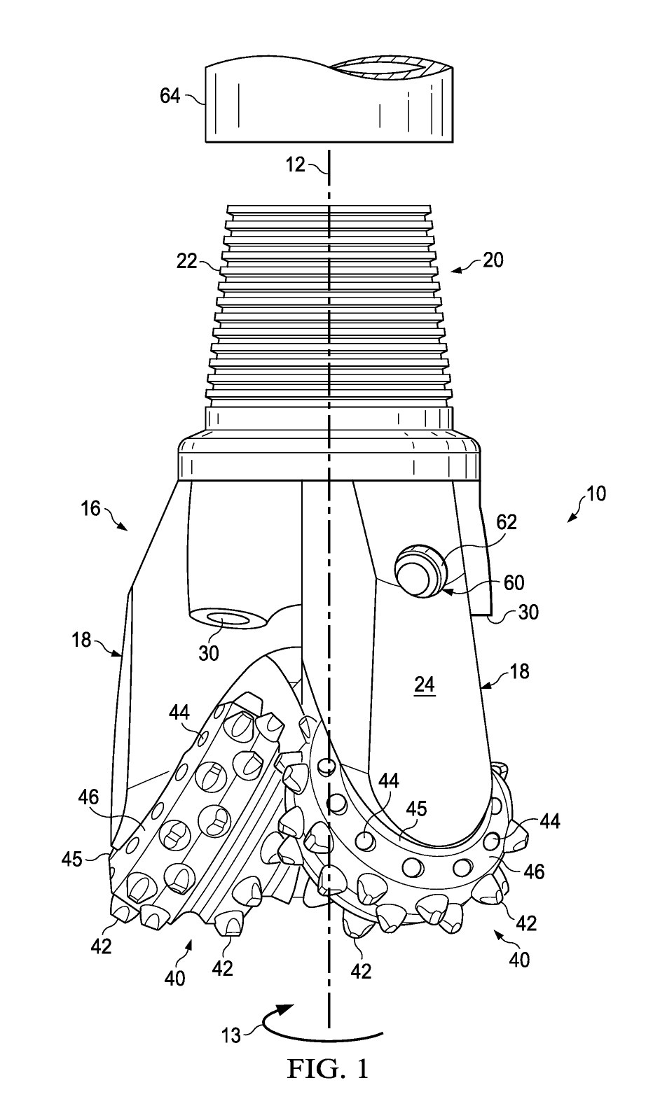

A downhole tool according the present disclosure may include any downhole tool containing at least one bearing. For embodiment, it may be an earth-boring drill bit or other components of an oil or mining drilling operation. FIG. 1 is an elevation view of one embodiment of roller cone drill bit 10, in accordance with embodiments of the present disclosure. Drill bit 10 as shown in FIG. 1 may be referred to as a “roller cone drill bit,” “rotary cone drill bit,” “rotary rock bit,” or “rock bit.” Drill bit 10 may include various types of such bits. Roller cone drill bits may have at least one support arm with a respective cone assembly rotatably disposed thereon.

A drill string 64 may be attached to and rotate drill bit 10 relative to bit rotational axis 12. Drill bit 10 may rotate as indicated by arrow 13. Cutting action associated with forming a wellbore in a downhole formation may occur as cone assemblies, indicated generally at 40, engage and roll around the bottom or downhole end of a borehole or wellbore (not shown) in response to rotation of drill bit 10.

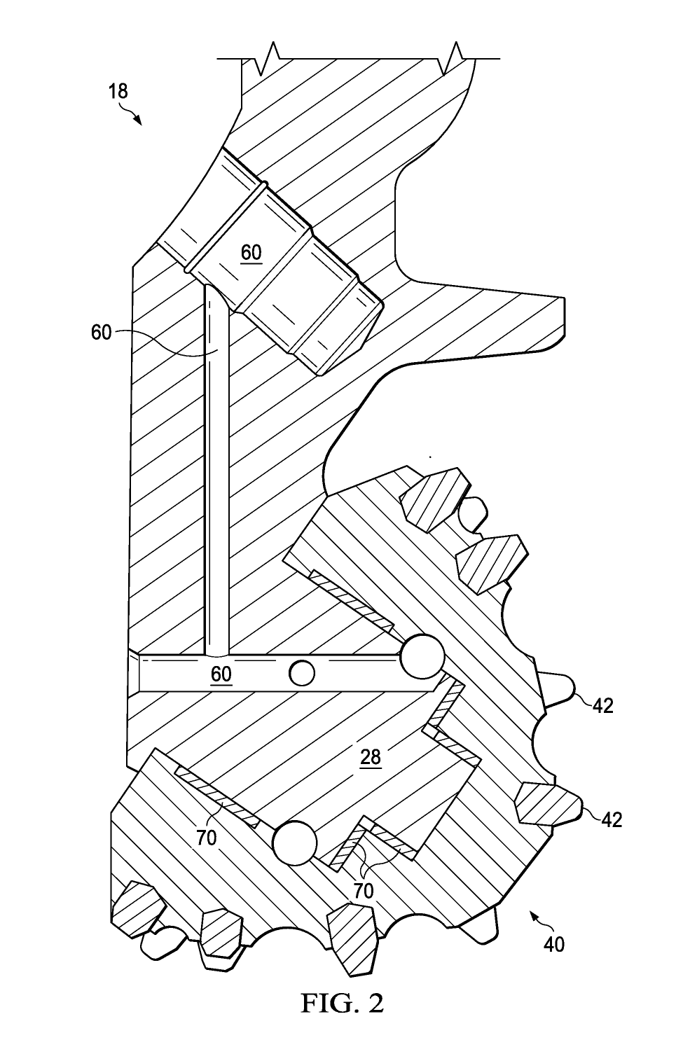

Each cone assembly 40 may be attached with and rotate relative to exterior portions of associated spindle or journal 28, as shown in FIG. 2. Cone assembly 40 may be referred to as a “roller cone,” “rotary cone cutter,” “roller cone cutter,” “rotary cutter assembly” and “cutter cone assembly.” Each of cone assemblies 40 may include a plurality of cutting elements or inserts 42 which penetrate and scrape against adjacent portions of a downhole formation in response to rotation of drill bit 10. Referring to FIG. 1 and FIG. 2, cone assemblies 40 may also include a plurality of compacts 44 disposed on respective gauge surface 46 of each cone assembly 40. Cutting elements 42 may include various types of compacts, inserts, milled teeth and welded compacts satisfactory for use with roller cone drill bits. Cone assembly 40 may also include generally circular base portion 45.

For some embodiments of the present disclosure, drill bit 10 may include bit body 16 having three support arms 18 extending therefrom. Only two support arms 18 may be seen in FIG. 1, but the teachings of the present disclosure may be used in drill bits with various numbers of support arms 18. Uphole portion or pin end 20 of drill bit 10 may include generally tapered, external threads 22. Threads 22 may be used to releasably engage drill bit 10 with the downhole end of an associated drill string or bottomhole assembly (not expressly shown).

Formation materials and other downhole debris created during impact between cutting elements or inserts 42 and adjacent portions of a downhole formation may be carried from the bottom or end of an associated wellbore by drilling fluid flowing from nozzles 30. Such drilling fluid may be supplied to drill bit 10 by a drill string (not expressly shown) attached to threads 22. Drilling fluid with formation cuttings and other downhole debris may flow upwardly around exterior portions of drill bit 10 and through an annulus (not expressly shown) formed between exterior portions of drill bit 10 and exterior portions of an attached drill string and inside diameter or side wall of the wellbore to an associated well surface (not expressly shown).

Each support arm 18 may include a respective lubricant system 60. Lubricant may refer to any fluid, grease, composite grease, or mixture of fluids and solids satisfactory for lubricating journal bearings, thrust bearings, bearing surfaces, bearing assemblies and/or other supporting structures associated with rotatably mounting one or more cone assemblies on a roller cone drill bit. Lubricant system 60 may include external end or opening 62 adjacent to exterior portion 24 of associated support arm 18.

FIG. 2 depicts a cross-section of a portion of roller cone bit drill bit 10 showing cone assembly 40 rotatably disposed on spindle or journal 28. Bearing 70 is disposed cone assembly 40 and spindle or journal 28. In the embodiment shown in FIG. 2, bearing 70 is formed on spindle or journal 28, although in alternative embodiments it may be formed in a similar fashion on cone assembly 40 or on both spindle or journal 28 and cone assembly 40. In one embodiment, bearing 70 may be formed on one of cone assembly 40 or spindle or journal 28 and the other may be coated with a different coating, such as a metal, particularly silver.

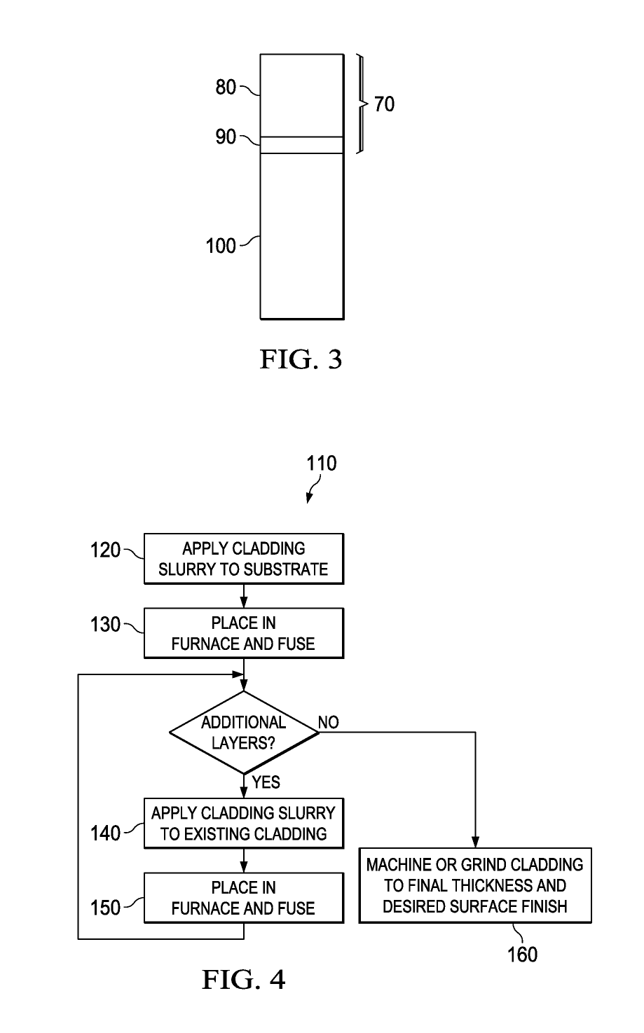

As shown in FIG. 2 and FIG. 3, at least one surface of or at least a portion of the surface of bearing 70 contains cladding 80 which includes low dilution zone 90. Low dilution zone 90 is disposed on bearing substrate 100, which is part of spindle or journal 28 (or, in an embodiment not shown in FIG. 2, may be part of cone assembly 40).

Cladding 80 may be between 0.010 inches and 0.040 inches thick, more specifically around 0.030 inches thick after final machining or grinding. Low dilution zone 90 may be between 0.0005 inches and 0.010 inches thick, more particularly between 0.001 inches and 0.005 inches thick. In general, low dilution zone 90 may be thinner than a corresponding high dilution zone that would occur if similar cladding were applied using welding. These effects may occur because there is a trade-off between hardness and brittleness in cladding 80. Iron or other metal from substrate 100 degrade the hardness, so more hardness-increasing materials are added to the cladding to compensate, making it more brittle and requiring the cladding to be thicker to compensate. If there is less iron in cladding 80, then the amount of hardness-increasing materials can be reduced, reducing the brittleness and allowing thinner cladding.

Low dilution zone 90 may also contain less iron or other metal from substrate 100 than a corresponding high dilution zone that would occur if similar cladding were applied using welding.

Due to the reduced proportion of low dilution zone 90 in cladding 80 and the lower amount of iron in low dilution zone 90 as compared to cladding that is attached via welding, bearing 70 may contain less cladding overall, typically in the form of thinner cladding, than a similar bearing formed by welding. This results in savings in material costs.

Additionally, cladding 80 may have lower proportions of harder elements that are added to cladding to prevent cracking due to undesirable properties conferred by iron or other metal from substrate 100.

In addition, because cladding 80 is applied as a paste or slurry, there are substantially no gaps between cladding 80 and substrate 100, even on irregular surfaces. A similar lack of gaps is difficult to obtain using welding, particularly on irregular surfaces. Gaps are common failure points, so the reduction of gaps increases the life of bearing 70.

Bearing 70, in some embodiments (not shown) may contain multiple layers of cladding 80. In such an embodiment, only the layer of cladding 80 adjacent to substrate 100 has a low dilution zone 90. The additional layers of cladding 80 contain substantially no iron or other metal from substrate 100 and thus are not diluted. In one embodiment, each cladding layer 80 may be 0.010 inches thick.

Spindle or journal 28 may be formed from normal bit body materials, such as steel and steel alloys, particularly high alloy steel. Roller assembly 40 may be formed from normal roller assembly materials, such as steel and steel alloys, particularly high alloy steel.

Cladding 80 may be formed from a Group VIII metal, such as cobalt (Co), nickel (Ni), or iron (Fe), or a combination of Group VIII metals, and an alloying element such as carbon (C), tungsten (W), molybdenum (Mo), chromium (Cr), tantalum (Ta), titanium (Ti), vanadium (V), niobium (Nb), boron (B) or combinations thereof. Some alloying elements may be present as carbides in the final cladding.

Low dilution zone 90 is formed from the same material as cladding 80, but contains some iron or other metal that migrates from substrate 100. In one embodiment, low dilution zone 90 may contain 5% by proportion of atoms or less iron or other metal from substrate 100.

Low dilution zone 90 or cladding 80, in some embodiments, are substantially homogenous at a given distance from substrate 100.

Bearing 70 may exhibit improved anti-galling as compared to cladding of similar composition applied using arc welding processes. In one embodiment, bearing 70 may be able to withstand a 25,000 ft/lbs. load in a journal bearing test without exhibiting galling.

Bearing 70 may also exhibit other improved wear properties as compared to cladding of similar composition applied using arc welding processes. Bearing 70 may also have a high load carrying capacity, such as greater than 25,000 ft/lbs.

In a specific embodiment, bearing 70 is a sealed bearing, as depicted in FIG. 1 and FIG. 2. In such an instance, the bearing is located within lubrication system 60.

The present disclosure also relates to a cladding process. Such a process may be used, in some embodiments, to apply cladding 80 to a roller cone drill bit 10 as described above. FIG. 4 depicts cladding process 110. In step 120, the cladding slurry (which may be in the form of a slurry or paste) is applied to substrate 100. In step 130, the cladding slurry is placed in a furnace and metallurgically fused to substrate 100. If additional cladding layers are desired, for instance to obtain a desired overall thickness of cladding 80, in step 140, cladding slurry is applied to the existing cladding layer. Then in step 150, the cladding slurry is placed in a furnace and fused to the existing cladding layer. Steps 140 and 150 may be repeated as many times as is desired or needed to obtain cladding of a desired thickness. After fusion of the final cladding layer, in step 160 cladding 80 is machined or ground to a final thickness and desired surface finish.

The cladding slurry may contain powdered metals in the proportions they will eventually be found in cladding 80. However, the alloying element may not form a carbide until fusion step 130 or 150. In low dilution zone 90, 5% by proportion of atoms or less of iron or other metal from substrate 100 may enter the cladding slurry during the cladding process, particularly during fusion step 130. Iron or other metal from substrate 100 may enter low dilution zone 90 uniformly, such that low dilution zone 90 has a homogenous composition at a given distance from substrate 100.

The cladding slurry may contain other components to form a slurry, such as a flux material. In some embodiments, these components may exit the slurry during fusion step 130 or 150.

In step 120 or step 140, the cladding slurry may be applied by dipping the substrate in the cladding slurry or by using a brush or spray. The cladding slurry may be formulated to function with the desired method of application.

Fusion step 130 or 150 may take place at low pressure, for embodiment in a vacuum furnace. In one embodiment, they may take place in a non-reactive atmosphere, such as an argon atmosphere. Fusion step 130 or 150 may take place at a temperature of 2200° F.

Each layer of cladding slurry and each subsequent layer of cladding 80 is 0.010 inches thick. In one embodiment, three layers may be applied for a cladding that is 0.030 inches thick.

In some embodiments, all or some steps of process 110 may be automated. In some embodiments, all arms of roller cone drill bit 10 may be subjected to process 110 at the same time. In some embodiments batch processing of arms 18 or cones 40 may occur.

Bearing described herein are friction bearings, but cladding with a low dilution zone may also be used on roller bearings, friction races, and collar races.

In a specific embodiment, elements of which may be used in combination with other embodiments, the disclosure relates to a bearing including a substrate including a substrate metal, and cladding metallurgically fused to the substrate and including a low dilution zone, wherein the low dilution zone includes 5% by proportion of atoms or less of the substrate metal. The bearing may further include a roller cone assembly, wherein the substrate is located on a portion of the roller cone assembly that makes contact with a spindle or journal. The substrate may be disposed on part of a spindle or journal of a support arm. The substrate metal may be iron. The cladding may include a Group VIII metal and an alloying element. The Group VII metal may be selected from the group consisting of cobalt (Co), nickel (Ni), or iron (Fe), and any combinations thereof, and the alloying element may be selected from the group consisting of carbon (C), tungsten (W), molybdenum (Mo), chromium (Cr), tantalum (Ta), titanium (Ti), vanadium (V), niobium (Nb), boron (B), and any combinations thereof. The alloying element may be present as a carbide. The cladding may include layers. The cladding may be between 0.010 inches and 0.040 inches thick. The low dilution zone may be between 0.0005 inches and 0.010 inches thick.

In another specific embodiment, the disclosure relates to a roller cone drill bit including a spindle or journal, a cone assembly disposed on the spindle or journal, and a bearing between the cone assembly and spindle or journal. The bearing includes a substrate including a substrate metal, and cladding metallurgically fused to the substrate and including a low dilution zone, wherein the low dilution zone includes 5% by proportion of atoms or less of the substrate metal. The substrate metal may be iron. The cladding may include a Group VIII metal and an alloying element. The Group VII metal may be selected from the group consisting of cobalt (Co), nickel (Ni), or iron (Fe), and any combinations thereof, and the alloying element may be selected from the group consisting of carbon (C), tungsten (W), molybdenum (Mo), chromium (Cr), tantalum (Ta), titanium (Ti), vanadium (V), niobium (Nb), boron (B), and any combinations thereof. The alloying element may be present as a carbide. The cladding may include layers. The cladding may be between 0.010 inches and 0.040 inches thick. The low dilution zone may be between 0.0005 inches and 0.010 inches thick.

In another specific embodiment, the disclosure relates to a method of applying a cladding to a substrate by applying a cladding slurry to the substrate and placing the cladding slurry in a furnace and then metallurgically fusing the cladding slurry to the substrate at an elevated temperature and reduced pressure to produce cladding on the substrate. The method may also include applying an additional cladding slurry to existing cladding, placing the additional cladding slurry in a furnace, metallurgically fusing the cladding slurry to the existing cladding at an elevated temperature and reduced pressure to produce additional cladding on the existing cladding, and repeating the steps until cladding of a desired thickness is obtained. The method may further include machining or grinding the cladding to a final thickness and desired surface finish.

Bearings described herein or produced using the methods described herein and downhole tools, such as drill bits, containing such bearings may exhibit improved bearing life. This may result in improvements in the downhole tool. In the drill bit embodiment, use of such bearings may allow for more aggressive drilling or reduced downhole trips. Bearings may also be used in other downhole tools, such as motors and completion tools.

Although only exemplary embodiments of the invention are specifically described above, it will be appreciated that modifications and variations of these embodiments are possible without departing from the spirit and intended scope of the invention. Measurements given here are “about” or “approximately” the recited number.

1. A bearing comprising:
a substrate including a substrate metal; and
cladding metallurgically fused to the substrate and including a low dilution zone, wherein the low dilution zone includes 5% by proportion of atoms or less of the substrate metal.

2. The bearing of claim 1, further comprising:
a roller cone assembly, wherein the substrate is located on a portion of the roller cone assembly that makes contact with a spindle or journal.

3. The bearing of claim 1, wherein the substrate is disposed on part of a spindle or journal of a support arm.

4. The bearing of claim 1, wherein the substrate metal is iron.

5. The bearing of claim 1, wherein the cladding comprises a Group VIII metal and an alloying element.

6. The bearing of claim 5, wherein the Group VII metal is selected from the group consisting of cobalt (Co), nickel (Ni), or iron (Fe), and any combinations thereof, and wherein the alloying element is selected from the group consisting of carbon (C), tungsten (W), molybdenum (Mo), chromium (Cr), tantalum (Ta), titanium (Ti), vanadium (V), niobium (Nb), boron (B), and any combinations thereof.

7. The bearing of claim 5, wherein the alloying element is present as a carbide.

8. The bearing of claim 1, wherein the cladding comprises layers.

9. The bearing of claim 1, wherein the cladding is between 0.010 inches and 0.040 inches thick.

10. The bearing of claim 1, wherein the low dilution zone is between 0.0005 inches and 0.010 inches thick.

11. A roller cone drill bit comprising:
a spindle or journal;
a cone assembly disposed on the spindle or journal; and
a bearing between the cone assembly and spindle or journal, the bearing including:
a substrate comprising a substrate metal; and
cladding metallurgically fused to the substrate and including a low dilution zone, wherein the low dilution zone includes 5% by proportion of atoms or less of the substrate metal.

12. The bit of claim 11, wherein the substrate metal is iron.

13. The bit of claim 11, wherein the cladding comprises a Group VIII metal and an alloying element.

14. The bit of claim 13, wherein the Group VII metal is selected from the group consisting of cobalt (Co), nickel (Ni), or iron (Fe), and any combinations thereof, and wherein the alloying element is selected from the group consisting of carbon (C), tungsten (W), molybdenum (Mo), chromium (Cr), tantalum (Ta), titanium (Ti), vanadium (V), niobium (Nb), boron (B), and any combinations thereof.

15. The bit of claim 13, wherein the alloying element is present as a carbide.

16. The bit of claim 11, wherein the cladding comprises layers.

17. The bit of claim 11, wherein the cladding is between 0.010 inches and 0.040 inches thick.

18. The bit of claim 11, wherein the low dilution zone is between 0.0005 inches and 0.010 inches thick.

19. A method of applying a cladding to a substrate, the method comprising:
applying a cladding slurry to the substrate; and
placing the cladding slurry in a furnace and metallurgically fusing the cladding slurry to the substrate at an elevated temperature and reduced pressure to produce cladding on the substrate.

20. The method of claim 19, further comprising:
applying an additional cladding slurry to existing cladding;
placing the additional cladding slurry in a furnace and metallurgically fusing the cladding slurry to the existing cladding at an elevated temperature and reduced pressure to produce additional cladding on the existing cladding; and
repeating the steps until cladding of a desired thickness is obtained.

21. The method of claim 19, further comprising machining or grinding the cladding to a final thickness and desired surface finish.
